(19) United States
(12) Patent Application Publication
(10) Pub. No.: US 2012/0324491 A1
(43) Pub. Date: Dec. 20, 2012

(54) VIDEO HIGHLIGHT IDENTIFICATION BASED ON ENVIRONMENTAL SENSING

(75) Inventors: Steven Bathiche, Kirkland, WA (US); Doug Burger, Bellevue, WA (US); David Rogers Treadwell, III, Seattle, WA (US); Joseph H. Matthews, III, Woodinville, WA (US)

(73) Assignee: MICROSOFT CORPORATION, Redmond, WA (US)

(21) Appl. No.: 13/163,379

(22) Filed: Jun. 17, 2011

(51) Int. Cl. H04H 60/33

(52) U.S. Cl. 725/10

(57) ABSTRACT

Embodiments related to identifying and displaying portions of video content taken from longer video content are disclosed. In one example embodiment, a portion of a video item is provided by receiving, for a video item, an emotional response profile for each viewer of a plurality of viewers, each emotional response profile comprising a temporal correlation of a particular viewer's emotional response to the video item when viewed by the particular viewer. The method further comprises selecting, using the emotional response profiles, a first portion of the video item judged to be more emotionally stimulating than a second portion of the video item, and sending the first portion of the video item to another computing device in response to a request for the first portion of the video item without sending the second portion of the video item.

### BACKGROUND

The identification of interesting portions of video content for playback, for example, as highlights, is often manually performed by the producer of the content. Thus, the portions chosen as highlights may be representative of the producer's best guess as to the interests of the broad viewing audience, rather than any particular individual or sub-group of the audience.

### SUMMARY

Various embodiments are disclosed herein that relate to selecting portions of video items based upon data from video viewing environment sensors. For example, one embodiment provides a method comprising receiving, for a video item, an emotional response profile for each viewer of a plurality of viewers, each emotional response profile comprising a temporal correlation of a particular viewer's emotional response to the video item when viewed by the particular viewer, and then selecting, using the emotional response profiles, a first portion of the video item judged to be more emotionally stimulating than a second portion of the video item. The selected first portion is then sent to another computing device in response to a request for the first portion of the video item without sending the second portion of the video item.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 schematically shows viewers watching video items within video viewing environments according to an embodiment of the present disclosure.

FIGS. 2A-B show a flow diagram depicting a method of providing requesting computing devices with portions of video content taken from longer video content items according to an embodiment of the present disclosure.

FIG. 3 schematically shows embodiments of a viewer emotional response profile, a viewing interest profile, and an aggregated viewer emotional response profile.

FIG. 4 schematically shows example scenarios for selecting emotionally stimulating portions of a video item to be sent to a requesting computing device according to an embodiment of the present disclosure.

### DETAILED DESCRIPTION

As mentioned above, selecting portions of video content items, such as sports presentations or movies, for use as highlights, trailers, or other such edited presentation has generally relied up on human editorial efforts. More recently, scraping has been used to aggregate computer network-accessible content into an easily browsable format to assist with content discovery. Scraping is an automated approach in which programs are used to harvest information from one or more content sources such as websites, semantically sort the information, and present the information as sorted so that a user may quickly access information customized to the user's interest.

Scraping may be fairly straightforward where entire content items are identified in the scrape results. For example, still images, video images, audio files, and the like may be identified in their entirety by title, artist, keywords, and other such metadata applied to the content as a whole. However, the identification of intra-video clips (i.e. video clips taken from within a larger video content item) poses challenges. For example, many content items may lack intra-media metadata that allows clips of interest to be identified and separately pulled from the larger content item. In other cases, video content items may be stored as a collection of segments that can be separately accessed. However, such segments may still be defined via human editorial input.

Thus, the disclosed embodiments relate to the automated identification of portions of video content that may be of particular interest compared to other portions of the same video content, and presenting the identified portions to viewers separate from the other portions. The embodiments may utilize viewing environment sensors, such as image sensors, depth sensors, acoustic sensors, and potentially other sensors such as biometric sensors, to assist in determining viewer preferences for use in identifying such segments. Such sensors may allow systems to identify individuals, detect and understand human emotional expressions of the identified individuals, and utilize such information to identify particularly interesting portions of a video content item.

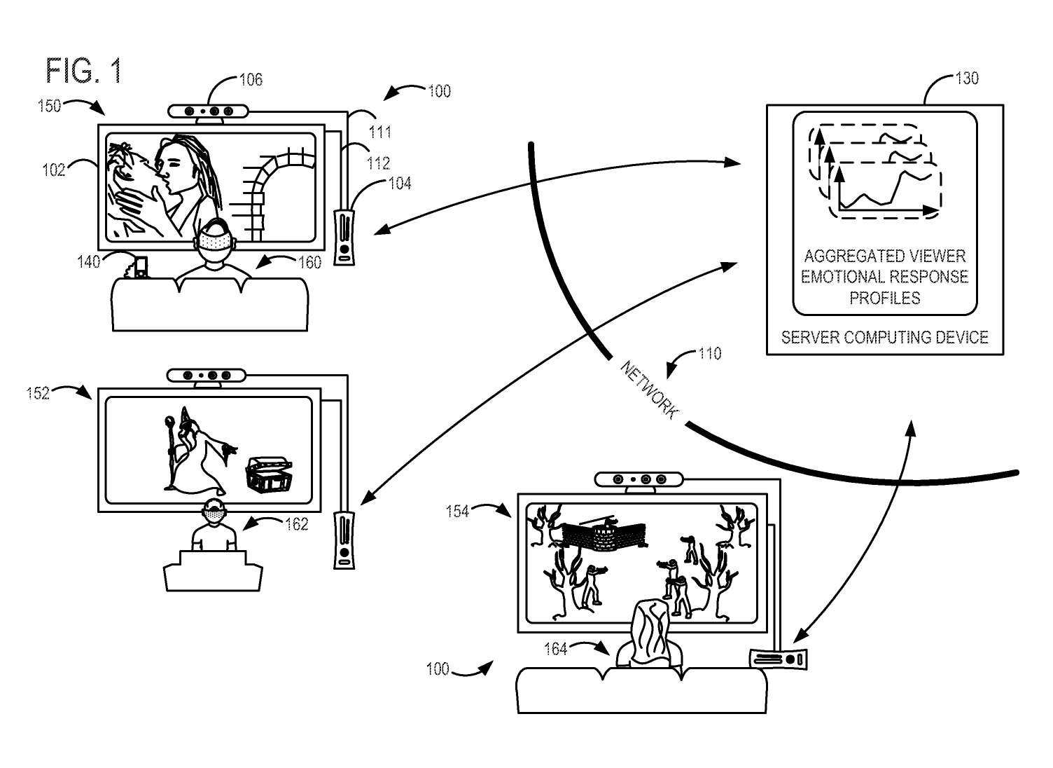

FIG. 1 schematically shows viewers (shown in FIG. 1 as 160, 162, and 164) watching video items (shown in FIG. 1 as 150, 152, and 154, respectively), each being viewed on a respective display 102 (as output via display output 112) within a respective video viewing environment 100 according to an embodiment of the present disclosure. In one embodiment, a video viewing environment sensor system 106 connected with a media computing device 104 (via input 111) provides sensor data to media computing device 104 to allow media computing device 104 to detect viewer emotional responses within video viewing environment 100. It will be understood that, in various embodiments, sensor system 106 may be implemented as a peripheral or built-in component of media computing device 104.

In turn, emotional response profiles of the viewers to the video items are sent to a server computing device 130 via network 110, where, for each of the video items, the emotional responses from a plurality of viewers are synthesized into an aggregated emotional response profile for that video item. Later, a requesting viewer seeking an interesting or emotionally stimulating video clip taken from one of those video items may receive a list of portions of those video items judged to be more emotionally stimulating than other portions of those same items. From that list, the requesting viewer may request one or more portions of those video item(s) to view, individually or as a compilation. On receiving the request, the server computing device sends the requested portions to the requesting computing device without sending the comparatively less stimulating and/or less interesting portions of those video item(s). Thus, the requesting viewer is provided with a segment of the video item that the requesting viewer may likely find interesting and emotionally stimulating. Likewise, such analysis may be performed on plural video items to present a list of potentially interesting video clips taken from different video content items. This may help in content discovery, for example.

Video viewing environment sensor system 106 may include any suitable sensors, including but not limited to one or more image sensors, depth sensors, and/or microphones or other acoustic sensors. Data from such sensors may be used by computing device 104 to detect facial and/or body postures and gestures of a viewer, which may be correlated by media computing device 104 to human affect displays. As an example, such postures and gestures may be compared to predefined reference affect display data, such as posture and gesture data, that may be associated with specified emotional states. It will be understood that the term “human affect displays” as used herein may represent any detectable human response to content being viewed, including but not limited to human emotional expressions and/or detectable displays of human emotional behaviors, such as facial, gestural, and vocal displays, whether performed consciously or subconsciously.

Media computing device 104 may process data received from sensor system 106 to generate temporal relationships between video items viewed by a viewer and each viewer's emotional response to the video item. As explained in more detail below, such relationships may be recorded as a viewer's emotional response profile for a particular video item and included in a viewing interest profile cataloging the viewer's video interests. This may allow the viewing interest profile for a requesting viewer to be later retrieved and used to select portions of one or more video items of potential interest to the requesting viewer.

As a more specific example, image data received from viewing environment sensor system 106 may capture conscious displays of human emotional behavior of a viewer, such as an image of a viewer 160 cringing or covering his face. In response, the viewer's emotional response profile for that video item may indicate that the viewer was scared at that time during the item. The image data may also include subconscious displays of human emotional states. In such a scenario, image data may show that a user was looking away from the display at a particular time during a video item. In response, the viewer's emotional response profile for that video item may indicate that she was bored or distracted at that time. Eye-tracking, facial posture characterization and other suitable techniques may also be employed to gauge a viewer's degree of emotional stimulation and engagement with video item 150.

In some embodiments, an image sensor may collect light within a spectral region that is diagnostic of human physiological conditions. For example, infrared light may be used to approximate blood oxygen levels and/or heart rate levels within the body. In turn, such levels may be used to estimate the person's emotional stimulation.

Further, in some embodiments, sensors that reside in other devices than viewing environment sensor system 106 may be used to provide input to media computing device 104. For example, in some embodiments, an accelerometer and/or other sensors included in a mobile computing device 140 (e.g., mobile phones and laptop and tablet computers) held by a viewer 160 within video viewing environment 100 may detect gesture-based or other emotional expressions for that viewer.

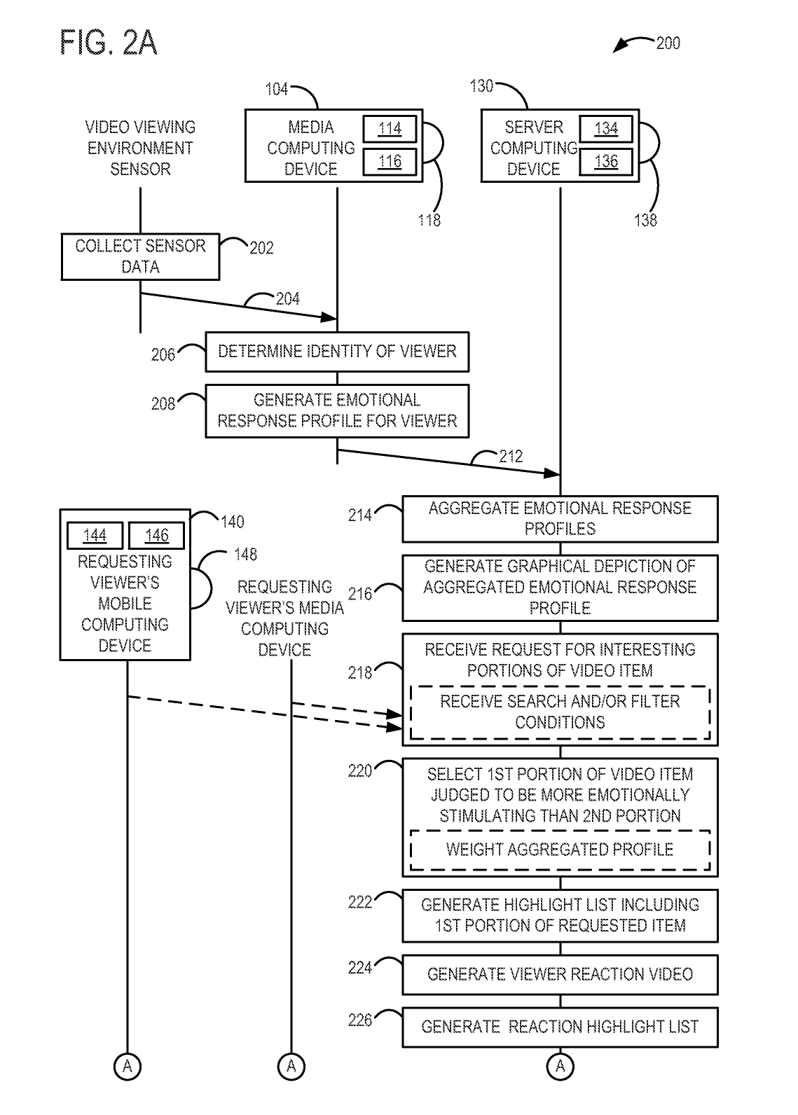

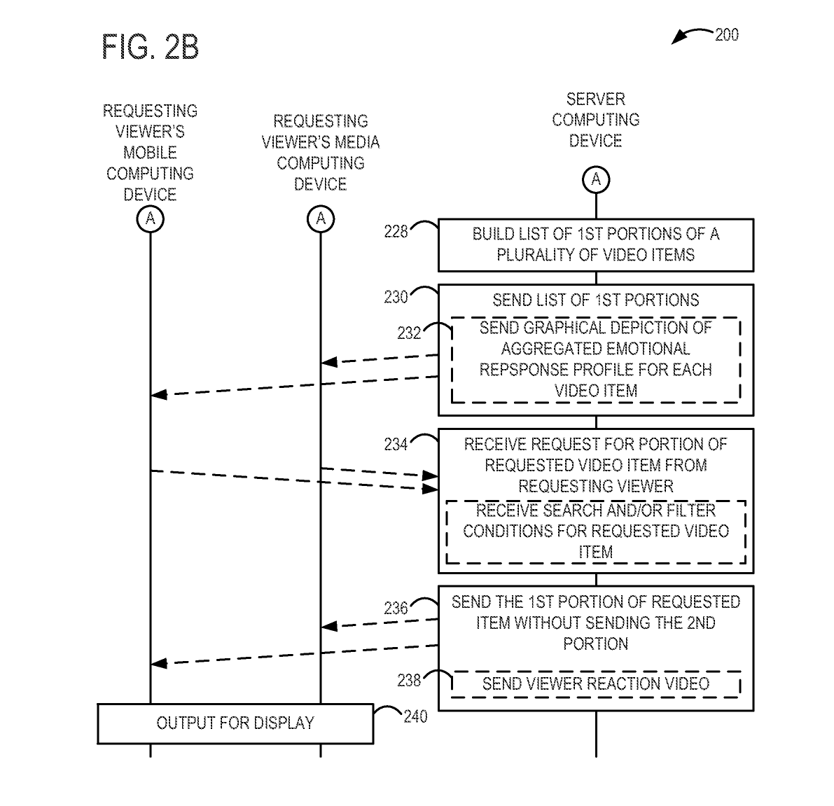

FIGS. 2A-B show a flow diagram for an embodiment of a method 200 for providing requesting computing devices with potentially interesting portions of video content taken from longer video content. It will be appreciated that the depicted embodiment may be implemented via any suitable hardware, including but not limited to embodiments of the hardware referenced in FIGS. 1 and 2A-B.

As shown in FIG. 2A, media computing device 104 includes a data-holding subsystem 114 that may hold instructions executable by a logic subsystem 116 to implement various tasks disclosed herein. Further, media computing device 104 also may include or be configured to accept removable computer-readable storage media 118 configured for storing instructions executable by logic subsystem 116. Server computing device 130 is also depicted as including a data-holding subsystem 134, a logic subsystem 136, and removable computer storage media 138.

In some embodiments, sensor data from sensors on a viewer's mobile device may be provided to the media computing device. Further, supplemental content related to a video item being watched may be provided to the viewer's mobile device. Thus, in some embodiments, a mobile computing device 140 may be registered with media computing device 104 and/or server computing device 130. Suitable mobile computing devices include, but are not limited to, mobile phones and portable personal computing devices (e.g., laptops, tablet, and other such computing devices).

As shown in FIG. 2A, mobile computing device 140 includes a data-holding subsystem 144, a logic subsystem 146, and computer storage media 148. Aspects of such data-holding subsystems, logic subsystems, and computer storage media as referenced herein will be described in more detail below.

At 202, method 200 includes collecting sensor data at the video viewing environment sensor, and potentially from mobile computing device 140 or other suitable sensor-containing devices. At 204, method 200 comprises sending the sensor data to the media computing device, which receives the input of sensor data. Any suitable sensor data may be collected, including but not limited to image sensor data, depth sensor data, acoustic sensor data, biometric sensor data, etc.

At 206, method 200 includes determining an identity of a viewer in the video viewing environment from the input of sensor data. In some embodiments, the viewer's identity may be established from a comparison of image data collected by the sensor data with image data stored in the viewer's personal profile. For example, a facial similarity comparison between a face included in image data collected from the video viewing environment and an image stored in the viewer's profile may be used to establish the identity of that viewer. A viewers' identity also may be determined from acoustic data, or any other suitable data.

At 208, method 200 includes generating an emotional response profile for the viewer, the emotional response profile representing a temporal correlation of the viewer's emotional response to the video item being displayed in the video viewing environment. Put another way, the viewer's emotional response profile for the video item indexes that viewer's emotional expressions and behavioral displays as a function of a time position within the video item.

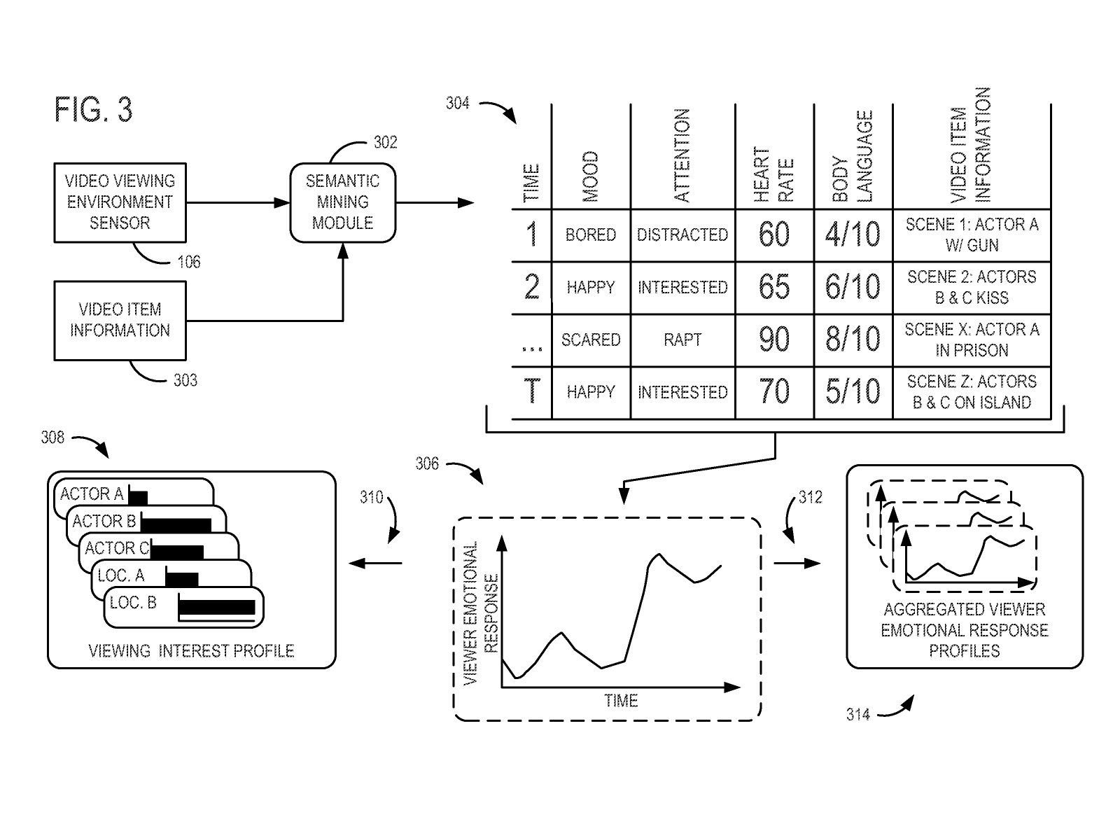

FIG. 3 schematically shows an embodiment of a viewer emotional response profile 304. As shown in FIG. 3, viewer emotional response profile 304 is generated by a semantic mining module 302 running on one or more of media computing device 104 and server computing device 130 using sensor information received from one or more video viewing environment sensors. Using data from the sensor and also video item information 303 (e.g., metadata identifying particular video item the viewer was watching when the emotional response data was collected and where in the video item the emotional response occurred), semantic mining module 302 generates viewer emotional response profile 304, which captures the viewer's emotional response as a function the time position within the video item.

In the example shown in FIG. 3, semantic mining module 302 assigns emotional identifications to various behavioral and other expression data (e.g., physiological data) detected by the video viewing environment sensors. Semantic mining module 302 also indexes the viewer's emotional expression according to a time sequence synchronized with the video item, for example, by time of various events, scenes, and actions occurring within the video item. Thus, in the example shown in FIG. 3, at time index 1 of a video item, semantic mining module 302 records that the viewer was bored and distracted based on physiological data (e.g., heart rate data) and human affect display data (e.g., a body language score). At later time index 2, viewer emotional response profile 304 indicates that the viewer was happy and interested in the video item, while at time index 3 the viewer was scared but was raptly focused on the video item.

FIG. 3 also shows a graphical representation of a non-limiting example viewer emotional response profile 306 illustrated as a plot of a single variable for simplicity. While viewer emotional response profile 306 is illustrated as a plot of a single variable (e.g. emotional state) as a function of time, it will be appreciated that an emotional response profile may comprise any suitable number of variables representing any suitable quantities.

In some embodiments, semantic mining module 302 may be configured to distinguish between the viewer's emotional response to a video item and the viewer's general temper. For example, in some embodiments, semantic mining module 302 may ignore those human affective displays detected when the viewer's attention is not focused on the display device, or may record information regarding the user's attentive state in such instances. Thus, as an example scenario, if the viewer is visibly annoyed because of a loud noise originating external to the video viewing environment, semantic mining module 302 may be configured not ascribe the detected annoyance with the video item, and/or may not record the annoyance at that temporal position within the viewer's emotional response profile for the video item. In embodiments in which an image sensor is included as a video viewing environment sensor, suitable eye tracking and/or face position tracking techniques may be employed to determine a degree to which the viewer's attention is focused on the display device and/or the video item.

A viewer's emotional response profile 304 for a video item may be analyzed to determine the types of scenes/objects/occurrences that evoked positive and negative responses in the viewer. For example, in the example shown in FIG. 3, video item information, including scene descriptions, are correlated with sensor data and the viewer's emotional responses. The results of such analysis may then be collected in a viewing interest profile 308. Viewing interest profile 308 catalogs a viewer's likes and dislikes for video media, as judged from the viewer's emotional responses to past media experiences. Viewing interest profiles are generated from a plurality of emotional response profiles, each emotional response profile temporally correlating the viewer's emotional response to a video item previously viewed by the viewer. Put another way, the viewer's emotional response profile for a particular video item organizes that viewer's emotional expressions and behavioral displays as a function of a time position within that video item. As the viewer watches more video items, the viewer's viewing interest profile may be altered to reflect changing tastes and interests of the viewer as expressed in the viewer's emotional responses to recently viewed video items.

By performing such analysis for other content items viewed by the viewer, as shown at 310 of FIG. 3, and then determining similarities between portions of different content items that evoked similar emotional responses, potential likes and dislikes of a viewer may be determined and then used to locate content suggestions for future viewing and/or video clip highlights for presentation. For example, FIG. 3 shows that the viewer prefers actor B to actors A and C and prefers location type B over location type A. Further, such analyses may be performed for each of a plurality of viewers in the viewing environment.

Turning back to FIG. 2A, method 200 includes, at 212, receiving, for a video item, emotional response profiles from each of a plurality of viewers. Thus, the emotional responses of many viewers to the same video item are received at 212 for further processing. These emotional responses may be received at different times (for example, in the case of a video item retrieved by different viewers for viewing at different times) or concurrently (for example, in the case of a live televised event). Once received, the emotional responses may be analyzed in real time and/or stored for later analysis, as described below.

At 214, method 200 includes aggregating a plurality of emotional response profiles from different viewers to form an aggregated emotional response profile for that video item. In some embodiments, method 200 may include presenting a graphical depiction of the aggregated emotional response profile at 216. Such views may provide a viewer with a way to distinguish emotionally stimulating and interesting portions of a video item from other portions of the same item at a glance, and also may provide a mechanism for a viewer to select such video content portions for view (e.g. where the aggregated profile acts as a user interface element that controls video content presentation).

Further, in some embodiments, such views may be provided to content providers and/or advertising providers so that those providers may discover those portions of video items that made emotional connections with viewers (and/or with viewers in various market segments). For example, in a live broadcast scenario, a content provider receiving such views may provide, in real time, suggestions to broadcast presenters about ways to engage and further connect with the viewing audience, potentially retaining viewers who might otherwise be tempted to change channels.

For example, FIG. 3 shows an embodiment of an aggregated emotional response profile 314 for a video item. As shown in FIG. 3, a plurality of emotional response profiles for a video item, each profile originating from a different viewer and/or a different viewing session of a same viewer, may be temporally correlated at 312 to generate aggregated emotional response profile 314. Additionally, in some embodiments, aggregated emotional response profile 314 may also be correlated with video item information in any suitable way (e.g., by video item genre, by actor, by director, screenwriter, etc.) to identify characteristics about the video item that triggered, to varying degrees and enjoyment levels, emotional experiences for the plurality of viewers. Additionally, an aggregated emotional response profile may be filtered based upon social network information, as described below.

Returning to FIG. 2A, method 200 includes, at 218, receiving a request for interesting portions of the video item, the request including the requesting viewer's identity. For example, the request may be made when the requesting viewer arrives at a video scrape site, when the requesting viewer's mobile or media computing device is turned on, or by input from the requesting viewer to a mobile, media or other computing device. It will be appreciated that the requesting viewer's identity may be received in any suitable way, including but not limited to the viewer identity determination schemes mentioned above.

In some embodiments, the request may include a search term and/or a filter condition provided by the requesting viewer, so that selection of the first portion of the video content may be based in part on the search term and/or filter condition. However, it will be appreciated that a requesting viewer may supply such search terms and/or filter conditions at any suitable point within the process without departing from the scope of the present disclosure.

At 220, method 200 includes selecting, using the emotional response profiles, a first portion of the video item judged to be more emotionally stimulating than a second portion of the video item. Thus, the emotional response may be used to identify portions of the video item that were comparatively more interesting to the aggregated viewing audience (e.g., the viewers whose emotional response profiles constitute the aggregated emotional response profile) than other portions evoking less of an emotional reaction in the audience. As a consequence, interesting portions of video media may be selected and/or summarized as a result of crowd-sourced emotional response information to longer video media.

In some embodiments, the crowd-sourced results may be weighted by the emotional response profiles for a group of potentially positively correlated viewers (e.g., people who may be likely to respond to a video item in a similar manner as the viewer as determined by a social relationship or other link between the viewers). Thus, in some embodiments, emotional response profiles for group members may have a higher weight than those for non-members. Once weights are assigned, selection may be performed in any suitable way. The weights could be assigned in any suitable manner, for example, a number in a range of zero to one. In one example, a weighted arithmetic mean may be calculated, as a function of time, to identify a mean magnitude of emotional stimulation at various time positions within the video item. As a consequence, the selection result may be comparatively more likely to be interesting to the viewer than an unweighted selection result (e.g., a selection result where all the aggregated emotional response profile is unweighted).

Further, in some embodiments, weights for a group (or a member of a group) may be based on viewer input. For example, weights may be based on varying levels of social connection and/or intimacy in a viewer's social network. In another example, weights may be based on confidence ratings assigned by the viewer that reflect a relative level of the viewer's trust and confidence in that group's (or member's) tastes and/or ability to identify portions of video items that the viewer finds interesting. In some other embodiments, confidence ratings may be assigned without viewer input according to characteristics, such as demographic group characteristics, suggesting positive correlations between group member interests and viewer interests. It will be understood that these methods for weighting emotional response profiles are presented for the purpose of example, and are not intended to be limiting in any manner.

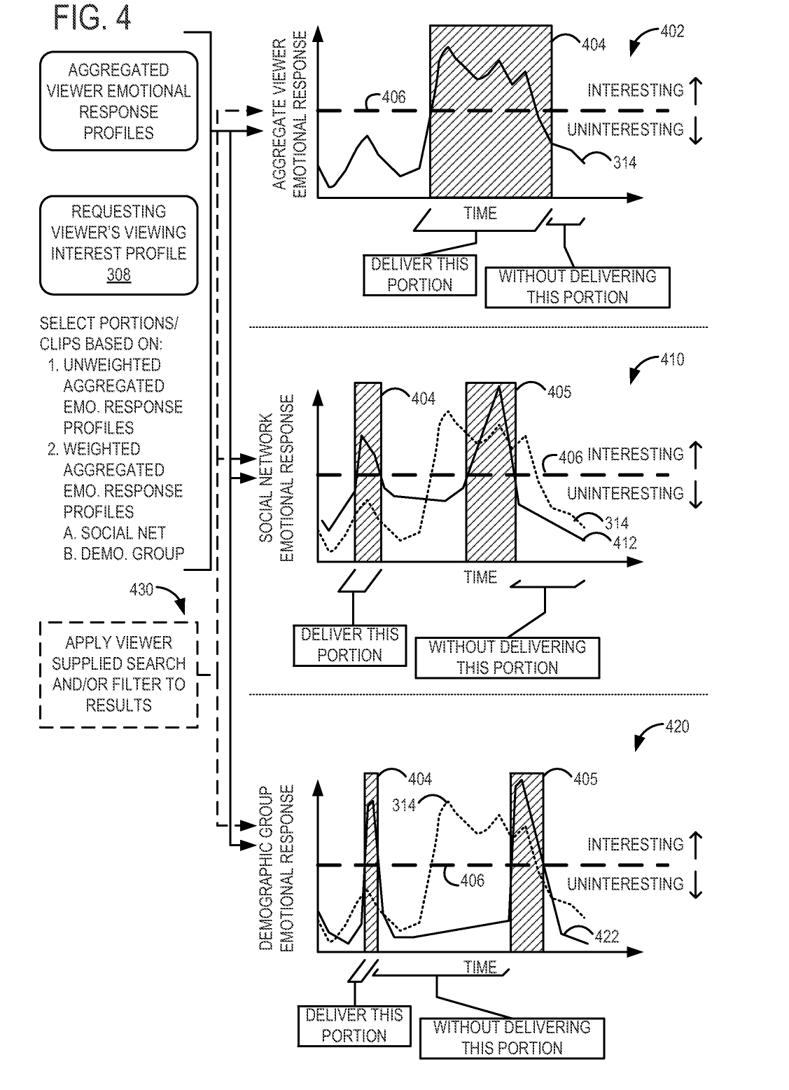

FIG. 4 schematically shows three example selection scenarios illustrative of the example embodiments described above. In scenario 402, the first portion 404 of the video item is selected based on an unweighted aggregated emotional response profile 314. In such embodiments, selecting the first portion of the video item may include basing the selection on a magnitude of an emotional response to the first portion of the video content item in the aggregated emotional response profile. In FIG. 4, a preselected threshold 406 is used to judge relative degrees of emotional stimulation evoked in the aggregated viewing audience by the video item. Preselected threshold 406 may be defined in any suitable way (e.g., as an absolute value or as a functional value, such as value corresponding to an interest level desirable to an advertiser relative to the content type and time of day at which the video item is being requested). Thus, first portion 404 corresponds to that portion of the video item that exceeds (within an acceptable tolerance) preselected threshold 406.

In scenario 410, aggregated viewer emotional response profile 314 is weighted by viewers in the requesting viewer's social network. Thus, selection of the first portion of the video item is based on using a subset of the aggregated emotional response profiles corresponding to viewers belonging to the requesting viewer's social network. It will be appreciated that a social network may be any suitable collection of people with a social link to the viewer such that the viewer's interests may be particularly well-correlated with the collective interest of the network members. Such a network may be user-defined or defined automatically by a common characteristic between users (e.g., alumni relationships). In scenario 410, weighted emotional response profile 412 is used with preselected threshold 406 to identify first portion 404. Aggregated emotional response profile 314 is shown in dotted line for reference purposes only. Selecting the first portion based on the requesting viewer's social network may provide the requesting viewer with portions of the video item that are interesting and relevant to the requesting viewer's close social connections. This may enhance the degree of personalization of the first portion selected for the requesting viewer.

In scenario 420, aggregated viewer emotional response profile 314 is weighted by viewers in a demographic group to which the requesting viewer belongs. Thus, selection of the first portion of the video item is based on using a subset of the aggregated emotional response profiles corresponding to viewers belonging to the requesting viewer's demographic group. It will be appreciated that a demographic group may be defined based upon any suitable characteristics that may lead to potentially more highly correlated interests between group members than between all users. Weighted emotional response profile 422 is then used with preselected threshold 406 to identify first portion 404. Aggregated emotional response profile 314 is shown in dotted line for reference purposes only. Selecting the first portion based on the requesting viewer's demographic group may help the requesting viewer discover portions of the video item that are interesting people with similar tastes and interests as the requesting viewer's.

It will be appreciated that further personalization may be realized by using viewer-provided filters, such as search terms and/or viewer-defined viewing interests. For example, in some embodiments, selection of the first portions may also be based on the requesting viewer's viewing interest profile 308. In some embodiments, selection may be further based on a requesting-viewer supplied search term and/or filter condition, as shown at 430 in FIG. 4.

In yet other embodiments, selection of the first portion of the video item may be based on a subset of the emotional response profiles selected by the viewer. For example, the viewer may opt to receive selected portions of video items and other content (such as the highlight lists, viewer reaction videos, and reaction highlight lists described below) that are based solely on the emotional response profiles of the viewer's social network. By filtering the emotional response profiles this way, instead of on a weighted or unweighted aggregated emotional response profile, relative level of personalization in the user experience may be enhanced.

Turning back to FIG. 2A, method 200 includes, at 222, generating a highlight list including the first portion of the video item and also including other portions of the video item based upon the emotional response profiles. Thus, for the particular video item, a list of emotionally stimulating and/or interesting portions of the video item is assembled. In some embodiments, the highlight list may be ranked according to a degree of emotional stimulation (such as a magnitude of emotional response recorded in the aggregated emotional response profile); by tags, comments, or other viewer-supplied annotation; by graphical representation (such as a heatmap); or by any other suitable way of communicating, to requesting viewers, the relative emotional stimulation evoked in the viewing audience by the video item.

Optionally, 222 may include, at 224, generating a viewer reaction video clip comprising a particular viewer's emotional, physical, and/or behavioral response to the video content item, as expressed by a human affect display recorded by a video viewing environment sensor. Such viewer reaction clips, at the option of the recorded viewer, may be stored with and/or presented concurrently with a related portion of the video item, so that a requesting viewer may view the video item and the emotional reaction of the recorded viewer to the video item. Thus, a requesting viewer searching for emotionally stimulating portions of a sporting event may also see clips of other viewer's reaction clips to that event. In some embodiments, the viewer reaction clips may be selected from viewers in the requesting viewer's social network and/or demographic group, which may further personalize the affinity that the requesting viewer experiences for the other viewer's reaction as shown in the viewer reaction clip.

In some embodiments, 222 may also include, at 226, generating a viewer reaction highlight clip list comprising video clips capturing reactions of each of one or more viewers to a plurality of portions of the video content item selected via the emotional response profiles. Such viewer reaction highlight clips lists may be generated by reference to the emotional reactions of other viewers to those clips in much the same was as interesting portions of the video item are selected, so that a requesting viewer may directly search for such viewer reaction clips and/or see popular and/or emotionally stimulating (as perceived by other viewers who viewed the viewer reaction clips) viewer reaction clips at a glance.

While the description of FIG. 2A has focused on the selection of a portion of a single video item for clarity, it will be appreciated that, in some embodiments, a plurality of portions may be selected from a plurality of respective video items. Thus, turning to FIG. 2B, method 200 includes, at 228, building a list of portions of a plurality of video items, and, at 230, sending a list of the respective portions. In some embodiments, highlight lists for the video item and/or for viewer reaction clips like those described above may be sent with the list of respective portions. Further, in some embodiments, 230 may include sending graphical depictions of the aggregated emotional response profile for each video item with the list at 232.

At 234, method 200 includes receiving a request for the first portion of the requested video item. Receiving the request at 234 may include receiving a request for a first portion of a single requested video item and/or receiving for a plurality of portions selected from respective requested video items.

In some embodiments, the request for the requested video item(s) may include a search term and/or a filter condition provided by the requesting viewer. In such embodiments, the search term and/or filter condition may allow the requesting viewer sort through a list of first portions of respective video items according to criteria (such as viewing preferences) provided in the search term and/or filter condition.

Responsive to the request received at 234, method 200 includes, at 236, sending the first portion of the video content item to the requesting computing device in without sending the second portion of the video content item. For example, each of the scenarios depicted in FIG. 4 shows a first portion 404 that will be sent to a requesting computing device while also showing another portion, judged emotionally less stimulating than the respective first portion 404 (as described above), that will not be sent. It will be appreciated that, in some embodiments, other emotionally stimulating portions of a video item may also be sent. For example, scenarios 410 and 420 of FIG. 4 each include an additional portion 405 (also shown in cross-hatch) judged to be emotionally stimulating relative to other portions of the video item. In some embodiments, these additional portions may be sent in response to the request.

In some embodiments where more than one respective first portions of video items were requested, 236 may include sending the respective first portions as a single video composition. Further, in some embodiments, 236 may include, at 238, sending the viewer reaction video clip. At 240, the portion (or portions) of the video item(s) sent are output for display.

As introduced above, in some embodiments, the methods and processes described in this disclosure may be tied to a computing system including one or more computers. In particular, the methods and processes described herein may be implemented as a computer application, computer service, computer API, computer library, and/or other computer program product.

FIG. 2A schematically shows, in simplified form, a non-limiting computing system that may perform one or more of the above described methods and processes. It is to be understood that virtually any computer architecture may be used without departing from the scope of this disclosure. In different embodiments, the computing system may take the form of a mainframe computer, server computer, desktop computer, laptop computer, tablet computer, home entertainment computer, network computing device, mobile computing device, mobile communication device, gaming device, etc.

The computing system includes a logic subsystem (for example, logic subsystem 116 of mobile computing device 104 of FIG. 2A, logic subsystem 146 of mobile computing device 140 of FIG. 2A, and logic subsystem 136 of server computing device 130 of FIG. 2A) and a data-holding subsystem (for example, data-holding subsystem 114 of mobile computing device 104 of FIG. 2A, data-holding subsystem 144 of mobile computing device 140 of FIG. 2A, and data-holding subsystem 134 of server computing device 130 of FIG. 2A). The computing system may optionally include a display subsystem, communication subsystem, and/or other components not shown in FIG. 2A. The computing system may also optionally include user input devices such as keyboards, mice, game controllers, cameras, microphones, and/or touch screens, for example.

The logic subsystem may include one or more physical devices configured to execute one or more instructions. For example, the logic subsystem may be configured to execute one or more instructions that are part of one or more applications, services, programs, routines, libraries, objects, components, data structures, or other logical constructs. Such instructions may be implemented to perform a task, implement a data type, transform the state of one or more devices, or otherwise arrive at a desired result.

The logic subsystem may include one or more processors that are configured to execute software instructions. Additionally or alternatively, the logic subsystem may include one or more hardware or firmware logic machines configured to execute hardware or firmware instructions. Processors of the logic subsystem may be single core or multicore, and the programs executed thereon may be configured for parallel or distributed processing. The logic subsystem may optionally include individual components that are distributed throughout two or more devices, which may be remotely located and/or configured for coordinated processing. One or more aspects of the logic subsystem may be virtualized and executed by remotely accessible networked computing devices configured in a cloud computing configuration.

The data-holding subsystem may include one or more physical, non-transitory, devices configured to hold data and/or instructions executable by the logic subsystem to implement the herein described methods and processes. When such methods and processes are implemented, the state of the data-holding subsystem may be transformed (e.g., to hold different data).

The data-holding subsystem may include removable media and/or built-in devices. The data-holding subsystem may include optical memory devices (e.g., CD, DVD, HD-DVD, Blu-Ray Disc, etc.), semiconductor memory devices (e.g., RAM, EPROM, EEPROM, etc.) and/or magnetic memory devices (e.g., hard disk drive, floppy disk drive, tape drive, MRAM, etc.), among others. The data-holding subsystem may include devices with one or more of the following characteristics: volatile, nonvolatile, dynamic, static, read/write, read-only, random access, sequential access, location addressable, file addressable, and content addressable. In some embodiments, the logic subsystem and the data-holding subsystem may be integrated into one or more common devices, such as an application specific integrated circuit or a system on a chip.

FIG. 2A also shows an aspect of the data-holding subsystem in the form of removable computer storage media (for example, removable computer storage media 118 of mobile computing device 104 of FIG. 2A, removable computer storage media 148 of mobile computing device 140 of FIG. 2A, and removable computer storage media 138 of server computing device 130 of FIG. 2A), which may be used to store and/or transfer data and/or instructions executable to implement the herein described methods and processes. Removable computer storage media may take the form of CDs, DVDs, HD-DVDs, Blu-Ray Discs, EEPROMs, and/or floppy disks, among others.

It is to be appreciated that the data-holding subsystem includes one or more physical, non-transitory devices. In contrast, in some embodiments aspects of the instructions described herein may be propagated in a transitory fashion by a pure signal (e.g., an electromagnetic signal, an optical signal, etc.) that is not held by a physical device for at least a finite duration. Furthermore, data and/or other forms of information pertaining to the present disclosure may be propagated by a pure signal.

The terms “module,” “program,” and “engine” may be used to describe an aspect of the computing system that is implemented to perform one or more particular functions. In some cases, such a module, program, or engine may be instantiated via the logic subsystem executing instructions held by the data-holding subsystem. It is to be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” are meant to encompass individual or groups of executable files, data files, libraries, drivers, scripts, database records, etc.

It is to be appreciated that a “service”, as used herein, may be an application program executable across multiple user sessions and available to one or more system components, programs, and/or other services. In some implementations, a service may run on a server responsive to a request from a client.

When included, a display subsystem may be used to present a visual representation of data held by the data-holding subsystem. As the herein described methods and processes change the data held by the data-holding subsystem, and thus transform the state of the data-holding subsystem, the state of display subsystem may likewise be transformed to visually represent changes in the underlying data. The display subsystem may include one or more display devices utilizing virtually any type of technology. Such display devices may be combined with the logic subsystem and/or the data-holding subsystem in a shared enclosure, or such display devices may be peripheral display devices.

It is to be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated may be performed in the sequence illustrated, in other sequences, in parallel, or in some cases omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. At a computing device, a method of compiling and provisioning requesting computing devices with portions of video content taken from longer video content, the method comprising:
receiving, for a video item, an emotional response profile for each viewer of a plurality of viewers, each emotional response profile comprising a temporal correlation of a particular viewer's emotional response to the video item when viewed by the particular viewer;
selecting, using the emotional response profiles, a first portion of the video item judged to be more emotionally stimulating than a second portion of the video item; and
sending the first portion of the video item to another computing device in response to a request for the first portion of the video item without sending the second portion of the video item.

2. The method of claim 1, wherein selecting a first portion of the video item includes weighting the emotional response profiles corresponding to viewers belonging to a social network to which a requesting viewer belongs more than the other emotional response profiles.

3. The method of claim 1, wherein selecting a first portion of the video item includes weighting the emotional response profiles corresponding to viewers belonging to a demographic group to which a requesting viewer belongs more than the other emotional response profiles.

4. The method of claim 1, further comprising generating a highlight list including the first portion of the video item and also including other portions of the video item based upon the emotional response profiles.

5. The method of claim 1, further comprising generating a viewer reaction video clip comprising the particular viewer's physical response to the video item, and wherein sending the first portion includes sending the viewer reaction video clip.

6. The method of claim 5, further comprising generating a viewer reaction highlight clip list comprising video clips capturing reactions of each of one or more viewers to a plurality of portions of the video item selected via the emotional response profiles.

7. The method of claim 1, wherein selecting the first portion of the video item further comprises aggregating a plurality of emotional response profiles to form an aggregated emotional response profile for the video item, and then selecting the first portion of the video item based upon a magnitude of an emotional response to the first portion of the video item in the aggregated emotional response profile.

8. The method of claim 1, further comprising:
receiving emotional response profiles for other video items;
for each of the other video items:
aggregating the emotional response profiles into an aggregated emotional response profile for the video item, and
selecting the first portion of the video item based upon a magnitude of an emotional response to the first portion in the aggregated emotional response profile; and
sending one or more of the respective first portions of the other video items without sending respective second portions of the other video items.

9. The method of claim 8, wherein sending the first portion of the video item includes sending one or more of the respective first portions of the other video items as a single video composition.

10. The method of claim 1, wherein the request includes a search term, and wherein selecting the first portion of the video item includes filtering based upon the search term when selecting the first portion of the video item.

11. A computing device for sending to requesting computing devices portions of video content taken from longer video content, the computing device comprising:
a logic subsystem; and
a data-holding subsystem holding instructions executable by the logic subsystem to:
receive emotional response profiles for a plurality of video items, each emotional response profile generated by a temporal correlation of a particular viewer's emotional response to a particular video item based upon data received from a sensor adapted to collect data related to the particular viewer's emotional response;
for each video item, select, using the emotional response profiles for that video item, a first portion of the video item judged to be more emotionally stimulating than a second portion of the video item; and
send one or more the respective first portions to another computing device in response to a request without sending the respective second portions.

12. The computing device of claim 11, further comprising instructions executable to, for each video item, generate a highlight list including the first portion of the video item and also including other portions of the video item based upon the viewer emotional response profiles for the video item.

13. The computing device of claim 12, further comprising instructions executable to generate a viewer reaction highlight clip list comprising video clips capturing reactions of each of one or more viewers to a plurality of portions of the particular video item selected via the emotional response profiles for the particular video item.

14. The computing device of claim 11, further comprising, for each video item, instructions executable to, for each video item:
aggregate the emotional response profiles for the plurality of viewers to form an aggregated emotional response profile for that video item; and
select the first portion of that video item based upon a magnitude of an emotional response to the first portion of that video item in the aggregated emotional response profile for that video item.

15. The computing device of claim 14, further comprising instructions executable to, for each video item:
generate a graphical depiction of the aggregated emotional response profile for that video item; and
send the graphical depiction to a requesting computing device for display.

16. The computing device of claim 14, further comprising instructions executable to:
receive an identification of a social network to which a requesting viewer belongs; and
based upon identification:
assign a weight to the emotional response profiles of the viewers in the social network, each of those weights being larger than weights assigned to other emotional response profiles, and
generate the magnitude based on a weighted emotional response profile calculation.

17. A computing system for sending requested portions selected from video items to a requesting viewer, comprising:
a display output configured to output video items to a display device;
a logic subsystem operatively connectable with the display device via the display output; and
a data-holding subsystem holding instructions executable by the logic subsystem to:
receive, from a server, a list of respective first portions of video items, the respective first portions selected based upon a respective magnitude of an emotional response to those respective first portions in viewer emotional response profiles for a plurality of viewers belonging to a social network to which the requesting viewer belongs, each emotional response profile representing, for a particular video item, a temporal correlation of a particular viewer's emotional response to the video item when viewed as a whole by the particular viewer,
send a request for the first portion of a requested video item, the requested video item selected from the list of respective first portions of video items,
receive, from the server, the first portion of the requested video item without receiving a second portion of the requested video item, and
output the first portion of the requested video item for display.

18. The computing system of claim 17, further comprising:
an input configured to receive image data from an image sensor, the logic subsystem being operatively connectable with the depth camera via the input; and
wherein the data-holding subsystem further holds instructions executable to:
receive an input of image data for a video viewing environment from the input,
generate emotional response data for the requesting viewer from the input of image data by a comparison of viewer affect display data included in the image data with predefined reference affect display data associated with specified emotional states, the emotional response data including the requesting viewer's emotional response to the first portion of the particular video content item as characterized by one or more of the specified emotional states,
send the emotional response data for the requesting viewer to the server,
receive, from the server, an updated list of respective first portions of video items, the updated list of respective first portions selected based upon a correlation of the emotional response data for the requesting viewer with the viewer emotional response profiles for the plurality of viewers belonging to the social network.

19. The computing system of claim 17, further comprising instructions to, for the requested video item, receive a graphical depiction of viewers' emotional responses to the requested video item and output the graphical depiction for display.

20. The computing system of claim 19, further comprising instructions to receive, from the server, a viewer reaction highlight clip list comprising video clips capturing reactions of each of one or more viewers of a plurality of portions of the requested video item selected via the viewer emotional response profiles.
